(19) United States
(12) Patent Application Publication
(10) Pub. No.: US 2024/0199438 A1
(43) Pub. Date: Jun. 20, 2024

(54) COMPOSITE MICROPARTICLE MANUFACTURING METHOD AND COMPOSITE MICROPARTICLES

(71) Applicant: Panasonic Intellectual Property Management Co., Ltd., Osaka (JP)

(72) Inventors: TAKESHI KOIWASAKI, Osaka (JP); TAKESHI UEDA, Hyogo (JP); HISAO NAGAI, Osaka (JP); TAKAFUMI OKUMA, Osaka (JP)

(21) Appl. No.: 18/504,209

(22) Filed: Nov. 8, 2023

Related U.S. Application Data
(63) Continuation of application No. PCT/JP2022/020500, filed on May 17, 2022.

(30) Foreign Application Priority Data
May 20, 2021 (JP) 2021-085463

(51) Int. Cl. C01G 3/02; B01J 21/06; B01J 23/72; B01J 35/39; B01J 37/34; C01G 23/047; C09D 133/06; C08K 3/22

(52) U.S. Cl. CPC C01G 3/02; B01J 21/063; B01J 23/72; B01J 35/39; B01J 37/34; C01G 23/047; C09D 133/06; C01P 2004/62; C01P 2004/64; C08K 2003/2241; C08K 2003/2248

(57) ABSTRACT

A composite microparticle manufacturing method includes: a step of preparing a first selective element-containing raw material and a second selective element-containing raw material, the first selective element-containing raw material containing one or more first selective elements selected from a copper element, a molybdenum element, and a silver element, the second selective element-containing raw material containing one or more second selective elements selected from titanium, germanium, silicon, tin, aluminum, zinc, zirconium, hafnium, iron, yttrium, niobium, tantalum, calcium, magnesium, indium, tungsten, molybdenum, and nickel; and a composite microparticle generation step of introducing both of the prepared raw materials into thermal plasma, evaporating the raw materials, and cooling the evaporated raw materials to generate composite microparticles including base particles and first selective element-containing microparticles being present on surfaces of the base particles, the base particles having an average particle diameter of from 10 nm to 300 nm inclusive.

### TECHNICAL FIELD

The present disclosure relates to a composite microparticle manufacturing method and composite microparticles used for various devices such as a catalyst and an antimicrobial or antiviral material.

### BACKGROUND ART

In recent years, application of nanometer-order microparticles to various devices has been studied. For example, metal microparticles of nickel are currently used in ceramic capacitors, and use of microparticles having a particle diameter of less than or equal to 200 nanometers and favorable dispersibility has been studied for next-generation ceramic capacitors.

A photocatalyst using titanium oxide is inexpensive, has excellent chemical stability, has high catalytic activity, and is harmless to a human body, so that the photocatalyst using titanium oxide is widely used as a photocatalyst (see, for example, PTLs 1 and 2).

However, titanium oxide exhibits photocatalytic activity only under ultraviolet irradiation, and thus cannot exhibit sufficient catalytic activity under indoor light containing almost no ultraviolet component. Therefore, a visible light-response type photocatalyst of a copper compound-carried titanium oxide exerting photocatalytic activity even under an indoor light such as a fluorescent lamp has been proposed (see, for example, PTL 3).

As a method for producing these copper compound-carried titanium oxides, a production method by a liquid phase method is known. For example, PTL 3 discloses a production method of adding a reducing agent for reducing divalent copper to monovalent copper to a suspension prepared by blending a divalent copper compound with titanium oxide in which a content of rutile type titanium oxide is more than or equal to 50 mol %.
PTL 1: Unexamined Japanese Patent Publication No. 2007-51263
PTL 2: Unexamined Japanese Patent Publication No. 2006-346651
PTL 3: WO 2013/002151 A

### SUMMARY OF THE INVENTION

A composite microparticle manufacturing method according to an aspect of the present disclosure includes: a step of preparing a first selective element-containing raw material and a second selective element-containing raw material, the first selective element-containing raw material containing one or more first selective elements selected from a copper element, a molybdenum element, and a silver element, the second selective element-containing raw material containing one or more second selective elements selected from titanium, germanium, silicon, tin, aluminum, zinc, zirconium, hafnium, iron, yttrium, niobium, tantalum, calcium, magnesium, indium, tungsten, molybdenum, and nickel; and a composite microparticle generation step of introducing both of the prepared raw materials into thermal plasma, evaporating the raw materials, and cooling the evaporated raw materials to generate composite microparticles including base particles and first selective element-containing microparticles being present on surfaces of the based particles, the base particles having an average particle diameter of from 10 nm to 300 nm inclusive and containing one or more oxides of the selected one or more second selective elements, the first selective element-containing microparticles having an average particle diameter of from 0.5 nm to 300 nm inclusive and composed of at least one of cuprous oxide, copper oxide, copper, molybdenum oxide, silver oxide, and silver.

Composite microparticles according to an aspect of the present disclosure includes: base particles having an average particle diameter of from 10 nm to 300 nm inclusive and containing an oxide of one element selected from germanium, silicon, tin, aluminum, zinc, zirconium, hafnium, iron, yttrium, niobium, tantalum, calcium, magnesium, indium, tungsten, molybdenum, and nickel; and microparticles being present on surfaces of the base particles, the microparticles having an average particle diameter of from 0.5 nm to 300 nm inclusive and composed of at least one of cuprous oxide, copper oxide, copper, molybdenum oxide, silver oxide, and silver.

Composite microparticles according to another aspect of the present disclosure includes: base particles having an average particle diameter of from 10 nm to 300 nm inclusive and containing two or more oxides of two or more elements selected from titanium, germanium, silicon, tin, aluminum, zinc, zirconium, hafnium, iron, yttrium, niobium, tantalum, calcium, magnesium, indium, tungsten, molybdenum, and nickel; and microparticles being present on surfaces of the base particles, the microparticles having an average particle diameter of from 10 nm to 300 nm inclusive and composed of at least one of cuprous oxide, copper oxide, copper, molybdenum oxide, silver oxide, and silver.

### BRIEF DESCRIPTION OF THE DRAWINGS

FIG. 1 is a diagram describing an example of a flow of a composite microparticle manufacturing method according to a first exemplary embodiment.

FIG. 2 is a schematic cross-sectional view illustrating a cross-sectional configuration of a thermal plasma apparatus.

FIG. 3 is a view showing results of powder X-ray diffraction measurement of composite microparticles obtained by the composite microparticle manufacturing method according to the first exemplary embodiment.

FIG. 4 shows a transmission electron image of composite microparticles obtained by the composite microparticle manufacturing method according to the first exemplary embodiment.

FIG. 5 is a view showing results of powder X-ray diffraction measurement of composite microparticles obtained by the composite microparticle manufacturing method according to a second exemplary embodiment.

FIG. 6 shows a transmission electron image of composite microparticles obtained by the composite microparticle manufacturing method according to the second exemplary embodiment.

FIG. 7 shows a transmission electron image of composite microparticles obtained by the composite microparticle manufacturing method according to a third exemplary embodiment.

FIG. 8 shows a transmission electron image of composite microparticles obtained by the composite microparticle manufacturing method according to a fourth exemplary embodiment.

FIG. 9 shows a transmission electron image of composite microparticles obtained by the composite microparticle manufacturing method according to a fifth exemplary embodiment.

### DESCRIPTION OF EMBODIMENT

In PTL 3, titanium oxide having high crystallinity is synthesized by a gas phase method, a divalent copper compound is blended with the titanium oxide, a suspension is stirred and prepared, and a reducing agent, such as alkali metal, alkaline earth metal, aluminum, zinc, amalgam of alkali metal or zinc, a hydride of boron or aluminum, a metal salt in a low oxidation state, hydrogen sulfide, sulfide, thiosulfate, oxalic acid, formic acid, ascorbic acid, a substance having an aldehyde bond, and an alcohol compound containing phenol, is further added to reduce divalent copper (Cu(II)) to monovalent copper (Cu(I)).

In the conventional manufacturing method, there are a plurality of steps, the production cost is high, and synthesis in a liquid phase is included, so that usable solvents are limited, and when the produced particles are used, complicated treatment such as solvent substitution may be required. There is a problem in that it is difficult to adjust the reducing agent and the reducing agent remains as impurities.

An object of the present disclosure is to provide a composite microparticle manufacturing method capable of easily producing composite microparticles containing cuprous oxide, copper oxide, copper, molybdenum oxide, silver oxide, or silver on surfaces of the composite microparticles.

A composite microparticle manufacturing method according to a first aspect includes: a step of preparing a first selective element-containing raw material and a second selective element-containing raw material, the first selective element-containing raw material containing one or more first selective elements selected from a copper element, a molybdenum element, and a silver element, the second selective element-containing raw material containing one or more second selective elements selected from titanium, germanium, silicon, tin, aluminum, zinc, zirconium, hafnium, iron, yttrium, niobium, tantalum, calcium, magnesium, indium, tungsten, molybdenum, and nickel; and a composite microparticle generation step of introducing both of the prepared raw materials into thermal plasma, evaporating the raw materials, and cooling the evaporated raw materials to generate composite microparticles including base particles and first selective element-containing microparticles being present on surfaces of the base particles, the base particles having an average particle diameter of from 10 nm to 300 nm inclusive and containing one or more oxides of the selected one or more second selective elements, the microparticles having an average particle diameter of from 0.5 nm to 300 nm inclusive and composed of at least one of cuprous oxide, copper oxide, copper, molybdenum oxide, silver oxide, and silver.

In the composite microparticle manufacturing method according to a second aspect, in the first aspect, the second selective element-containing raw material having a melting point higher than a melting point of the first selective element-containing raw material may be used.

In the composite microparticle manufacturing method according to a third aspect, in the first or second aspect, the first selective element-containing microparticles may be copper element-containing particles, and the composite microparticle generation step may include controlling an atmosphere such that an abundance ratio of cuprous oxide in the copper element-containing particles present on the surfaces of the base particles is more than or equal to 20 mol %.

In the composite microparticle manufacturing method according to a fourth aspect, in the first or third aspect, the one or more second selective elements may be titanium and the one or more oxides of the one or more second selective elements includes titanium oxide, and the composite microparticle generation step may include controlling an atmosphere such that a content of rutile type titanium oxide in the titanium oxide is more than or equal to 50 mol %.

In the composite microparticle manufacturing method according to a fifth aspect, in any one of the first to fourth aspects, a discharge gas of the thermal plasma may be at least one of inert gas, oxygen gas, and hydrogen gas.

In the composite microparticle manufacturing method according to a sixth aspect, in any one of the first to fifth aspects, a discharge gas of the thermal plasma may be a mixed gas of inert gas and oxygen gas, the oxygen gas being 0.1 vol % to 50 vol % in the mixed gas.

In the composite microparticle manufacturing method according to a seventh aspect, in any one of the first to sixth aspects, the composite microparticle generation step may include supplying a cooling gas to a terminal portion of the thermal plasma.

In the composite microparticle manufacturing method according to an eighth aspect, in the seventh aspect, the cooling gas may be at least one of oxygen gas and hydrogen.

Composite microparticles according to a ninth aspect includes: base particles having an average particle diameter of from 10 nm to 300 nm inclusive and containing an oxide of one element selected from germanium, silicon, tin, aluminum, zinc, zirconium, hafnium, iron, yttrium, niobium, tantalum, calcium, magnesium, indium, tungsten, molybdenum, and nickel; and microparticles being present on surfaces of the base particles, the microparticles having an average particle diameter of from 0.5 nm to 300 nm inclusive and composed of at least one of cuprous oxide, copper oxide, copper, molybdenum oxide, silver oxide, and silver.

Composite microparticles according to a tenth aspect includes: base particles having an average particle diameter of from 10 nm to 300 nm inclusive and containing two or more oxides of two or more elements selected from titanium, germanium, silicon, tin, aluminum, zinc, zirconium, hafnium, iron, yttrium, niobium, tantalum, calcium, magnesium, indium, tungsten, molybdenum, and nickel; and microparticles being present on surfaces of the base particles, the microparticles having an average particle diameter of from 0.5 nm to 300 nm inclusive and composed of at least one of cuprous oxide, copper oxide, copper, molybdenum oxide, silver oxide, and silver.

In the composite microparticles according to an eleventh aspect, in the tenth aspect, the two or more oxides of the selected two or more elements may include titanium oxide, and a content of rutile type titanium oxide in the titanium oxide may be more than or equal to 50 mol %.

In the composite microparticles according to a twelfth aspect, in any one of the ninth to eleventh aspects, the microparticles may be copper element-containing particles, and an abundance ratio of cuprous oxide in the copper element-containing particles may be more than or equal to 20 mol %.

A resin composition according to a thirteenth aspect contains a resin; and the composite microparticles according to any one of the ninth to twelfth aspects in the resin.

A resin molded body according to a fourteenth aspect contains a resin; and the composite microparticles according to any one of the ninth to twelfth aspects in the resin.

A transparent sheet-shaped resin molded body according to a fifteenth aspect contains a resin; and the composite microparticles according to any one of the ninth to twelfth aspects in the resin.

A metal and ceramic molded body according to a sixteenth aspect contains a resin; and the composite microparticles according to any one of the ninth to twelfth aspects in the resin.

With the composite microparticle manufacturing method according to the present disclosure, it is possible to easily provide composite microparticles in which a copper compound and copper, molybdenum oxide, silver oxide, or silver used for various devices such as a catalyst and an antimicrobial or antiviral material is supported, coated, or combined.

Hereinafter, a composite microparticle manufacturing method and composite microparticles according to exemplary embodiments will be described in detail with reference to the drawings.

Note that the exemplary embodiments described below are intended to provide comprehensive or specific examples of the present disclosure. Numerical values, shapes, materials, constituent elements, arrangement positions and connection forms of the constituent elements, steps, processing order of the steps, and the like illustrated in the following exemplary embodiment are just an example, and are not intended to limit the present disclosure. Those components introduced in the following exemplary embodiments that are not recited in the independent claim(s) representing the most superordinate concept are illustrated herein as optional components. In the drawings, substantially identical configurations are denoted by identical reference numerals, and overlapped descriptions may be omitted or simplified.

Various elements shown in the drawings are only schematically shown for the present disclosure to be understood, and a dimensional ratio, appearance, or the like in the drawings may differ from actual ones.

### First Exemplary Embodiment

### [Composite Microparticle Manufacturing Method]

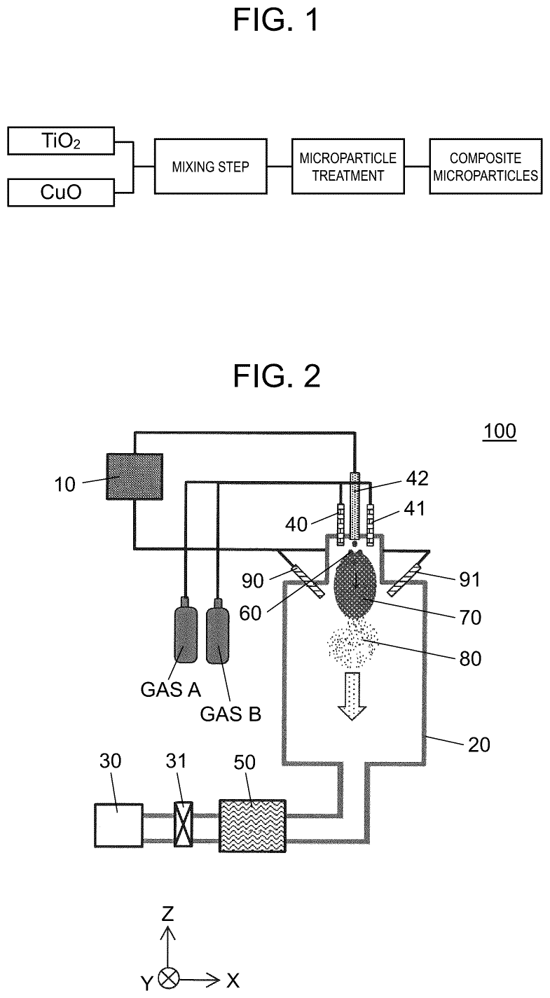

First, a composite microparticle manufacturing method according to the present first exemplary embodiment will be described with reference to FIGS. 1 and 2. FIG. 1 is a diagram describing an example of a flow of a method for manufacturing composite microparticles 80 according to the present first exemplary embodiment. FIG. 2 is a schematic cross-sectional view illustrating a cross-sectional configuration of thermal plasma apparatus 100.

A method for manufacturing composite microparticles 80 according to the present first exemplary embodiment includes a step of preparing raw materials and a composite microparticle generation step of introducing both of the raw materials into thermal plasma 70 (see FIG. 2), evaporating the raw materials, and cooling the raw materials to generate composite microparticles. In the step of preparing raw materials, a first selective element-containing raw material containing one or more first selective elements selected from a copper element, a molybdenum element, and a silver element, and a second selective element-containing raw material containing one or more second selective elements selected from titanium, germanium, silicon, tin, aluminum, zinc, zirconium, hafnium, iron, yttrium, niobium, tantalum, calcium, magnesium, indium, tungsten, molybdenum, and nickel. In the composite microparticle generation step, both of the prepared raw materials are into thermal plasma and evaporated, and the evaporated raw materials are cooled. As a result, it is possible to easily manufacture composite microparticles 80 including base particles and microparticles present on surfaces of the base particles, the base particles having an average particle diameter of from 10 nm to 300 nm inclusive and containing one or more oxides of one or more second selective elements selected from titanium, germanium, silicon, tin, aluminum, zinc, zirconium, hafnium, iron, yttrium, niobium, tantalum, calcium, magnesium, indium, tungsten, molybdenum, and nickel, and the microparticles having an average particle diameter of from 0.5 nm to 300 nm inclusive and composed of at least one of cuprous oxide, copper oxide, copper, molybdenum oxide, silver oxide, and silver.

According to the composite microparticle manufacturing method, composite microparticles excellent in antimicrobial or antiviral performance can be obtained. Since the average particle diameter of the base particles is as small as from 10 nm to 300 nm inclusive, diffuse reflection of light is eliminated, and the transmittance can be improved.

In composite microparticles 80, when the abundance ratio of cuprous oxide to the total of cuprous oxide, copper oxide, and copper constituting the copper element-containing particles present on the surfaces of the base particles is more than or equal to 20 mol %, the antiviral performance can be improved.

In composite microparticles 80, for example, when the selected element is titanium, titanium oxide is contained as base particles, and the content of rutile type titanium oxide in the titanium oxide is more than or equal to 50 mol %, photocatalytic activity can be improved.

Details of composite microparticles 80 obtained by the above manufacturing method will be described below.

Hereinafter, the method for manufacturing composite microparticles 80 according to the present first exemplary embodiment will be described with an example.

As illustrated in FIG. 1, the method for manufacturing composite microparticles 80 according to the present first exemplary embodiment includes a mixing step (step S1) of pulverizing and mixing the prepared second selective element-containing raw material and first selective element-containing raw material (here, TiO₂ and CuO) so as to have a predetermined particle diameter and a microparticle-forming step (composite microparticle generation step) (step S2) of evaporating the raw material obtained in step S1 by a thermal plasma apparatus and cooling the raw material to form microparticles.

Hereinafter, the method for manufacturing composite microparticles 80 will be described more specifically. Composite microparticles 80 are, for example, composite microparticles in which Cu₂O particles are supported on surfaces of TiO₂ particles as base particles.
(a) In the mixing step (step S1), rutile type TiO₂ as a raw material for TiO₂ and CuO as a raw material for Cu₂O are pulverized and mixed so as to have a predetermined particle diameter. For example, TiO₂ and CuO are prepared at a weight ratio of 90:10, and ground and mixed in a mortar. Thereby, mixed raw material 60 is obtained. Although depending on the treatment conditions with the thermal plasma, mixed raw material 60 to be introduced into thermal plasma can be evaporated as long as the particle diameter is less than or equal to 100 m, and microparticles having a small particle diameter and small variations in particle diameter can be manufactured. Therefore, the raw materials are pulverized and uniformly mixed so that the average particle diameter is less than or equal to 100 m. The method of mixing the raw materials is not limited thereto, and another method capable of pulverizing and mixing can be used.
(b) In the microparticle-forming step (composite microparticle generation step) (step S2), mixed raw material 60 obtained in the mixing step (step S1) is formed into microparticles by a thermal plasma method. Thermal plasma apparatus 100 illustrated in FIG. 2 is used to form mixed raw material 60 into microparticles.

### <Thermal Plasma Apparatus>

Thermal plasma apparatus 100 includes at least reaction chamber 20 as an example of a vacuum chamber, material supply unit 10, a thermal plasma generator (not illustrated) including, for example, a plurality of electrodes, and a composite microparticle recovery unit (here, bag filter 50) as an example of a recovery device that recovers the generated composite microparticles.

Reaction chamber 20 is surrounded by a grounded cylindrical reaction chamber wall. Material supply unit 10 supplies mixed raw material 60 into reaction chamber 20.

The thermal plasma generator (not illustrated) generates thermal plasma at about 10000° C. using, for example, high frequency, direct current, or alternating current power. In the thermal plasma generator, the plurality of electrodes are arranged at predetermined intervals on a side portion of a central portion of reaction chamber 20 so as to penetrate from the outside to the inside and a tip of each electrode protrudes into an internal space.

Bag filter 50 is disposed closer to reaction chamber 20 than dry pump 30, and recovers composite microparticles 80 generated in reaction chamber 20.

In thermal plasma apparatus 100 described above, thermal plasma 70 is generated in reaction chamber 20, and mixed material 60 supplied from material supply unit 10 is instantaneously evaporated by generated thermal plasma 70 and rapidly cooled in the gas phase, whereby composite microparticles 80 can be manufactured.

The microparticle-forming step (step S2) performed using a thermal plasma apparatus further includes, for example, steps of (1) introducing a raw material and vacuuming, (2) introducing gas and adjusting a pressure, (3) starting discharge and generating plasma, (4) suppling the raw material, (5) forming microparticles, and (6) stopping discharge and recovering microparticles.
(1) First, raw material introduction and vacuuming are performed. Specifically, mixed raw material 60 obtained by mixing TiO₂ and CuO is introduced into material supply unit 10. Subsequently, reaction chamber 20, the inside of the pipe in which the microparticle recovery unit (not illustrated) is disposed, and the inside of material supply unit 10 are evacuated by dry pump 30, thereby reducing the influence of retained oxygen. Although not illustrated, the microparticle recovery unit includes a cyclone capable of classifying particles having more than or equal to an arbitrary particle diameter and bag filter 50 capable of collecting desired composite microparticles 80.
(2) Gas introduction and pressure adjustment are performed. Specifically, gas is supplied from each of the plurality of gas supply devices A and B to material supply unit 10 and gas supply pipes 40 and 41 while adjusting the flow rate, and conductance valve 31 adjusts the pressure of reaction chamber 20 to a predetermined pressure. In the present exemplary embodiment, argon gas is introduced as discharge gas.
(3) Discharge is started to generate plasma. Specifically, a predetermined voltage is applied to a plurality of electrodes (not illustrated) of a plasma generator (not illustrated) to cause discharge (arc discharge). The arc discharge is ignited to generate thermal plasma 70. After the arc discharge is ignited, when the current applied to each electrode is stabilized, mixed raw material 60 is supplied from material supply unit 10 to reaction chamber 20.
(4) Mixed raw material 60 is particles pulverized and mixed to have an average particle diameter of less than or equal to 100 m. Mixed material 60 is introduced into material supply unit 10. Depending on the conditions of the plasma, when the particle diameter is larger than 0.5 m and less than or equal to 100 m, composite microparticles 80 having a particle diameter of nanometer order can be manufactured by being evaporated by thermal plasma. When particles having a particle diameter larger than 100 m are used as mixed raw material 60, mixed raw material 60 cannot be completely evaporated, and composite microparticles 80 to be produced may become large.

A gas is supplied from each of the plurality of gas supply devices A and B to material supply unit 10, and mixed raw material 60 is supplied to reaction chamber 20 together with the gas. Specifically, mixed raw material 60 is sent together with the gas from material supply unit 10 to material supply pipe 42, and is introduced together with the gas from material supply pipe 42 to reaction chamber 20. As a carrier gas for supplying mixed material 60 to reaction chamber 20, for example, argon gas is used.

A plurality of gas supply pipes 40 and 41 for sending mixed raw material 60 and composite microparticles 80 formed by discharge in a certain direction (in FIG. 2, the lower side in the longitudinal direction of the paper surface (−Z direction)) are provided around material supply pipe 42. The gas is supplied from gas supply pipes 40 and 41 in the above certain direction.
(5) Composite microparticles 80 are formed. Mixed raw material 60 supplied to reaction chamber 20 together with the gas is evaporated or vaporized (hereinafter, “evaporated”) when mixed raw material 60 passes through a region where thermal plasma 70 at a high temperature of about 10000° C. is generated (hereinafter, thermal plasma 70), and mixed raw material 60 is gasified. This mixed raw material gas flows in the certain direction by the flow of the gas from gas supply pipes 40 and 41, and at the moment when the mixed raw material gas comes out of thermal plasma 70, the mixed material gas is rapidly cooled and solidified in the gas phase to generate composite microparticles 80. The cooling rate at this time is, for example, about 10⁴ K/sec to 10⁵ K/sec. In the case, first, an element having a high melting point is solidified, and then an element having a lower melting point is solidified. Therefore, an oxide containing an element having a high melting point serves as base particles, and composite microparticles in which particles containing an element having a low melting point are supported on the surfaces of the base particles are formed. In the case of titanium and copper, titanium oxide that is an oxide of titanium having a high melting point serves as base particles, and composite microparticles in which copper element-containing particles containing copper having a lower melting point are supported on the surfaces of the base particles are generated.

The cooling for the mixed raw material gas may be natural cooling, but is not limited thereto. For example, cooling may be enhanced by the cooling gas (not illustrated) introduced from cooling gas supply pipes 90, 91 (FIG. 2) to the terminal portion of thermal plasma 70. In FIG. 2, gas supply pipes 40, 41, material supply pipe 42, and cooling gas supply pipes 90, 91 are connected to each other for the sake of simplicity, but this does not mean that these pipes are connected at all times. Optionally, gas may be selectively supplied to each pipe.
(6) The discharge is stopped, and composite microparticles 80 are recovered. Composite microparticles 80 generated by thermal plasma 70 are recovered by bag filter 50 by a flow of gas (carrier gas and discharge gas) from gas supply pipes 40 and 41 toward a microparticle recovery unit (not illustrated). As illustrated in FIG. 2, bag filter 50 is installed in front of dry pump 30 for exhausting.

When the treatment of the desired amount of mixed raw material 60 is completed, the discharge is stopped, and the generation of thermal plasma 70 is stopped. Composite microparticles 80 recovered by bag filter 50 are taken out. At this time, composite microparticles 80 may be taken out under an inert gas atmosphere such as nitrogen gas. Oxidation can be suppressed by taking out the composite microparticles 80 under an inert gas atmosphere.

In the present first exemplary embodiment, an example of using TiO₂ and CuO as raw materials for composite microparticles 80 has been described, but any of Ti and a Ti compound such as anatase type TiO₂, rutile type TiO₂, Ti, and TiO or a mixture thereof can be evaporated and thus can be used as a raw material for TiO₂. The crystal form of the base particles may be controlled by controlling the proportion of these raw materials. A Cu₂O source can also be used because any of Cu and a Cu compound such as CuO, Cu, Cu₂O, and CuCl₂ or a mixture thereof can be evaporated. The proportion of Cu₂O in the copper element-containing particles may be controlled by controlling the proportion of these raw materials.

In the present first exemplary embodiment, an example of using a solid powder raw material as the copper element-containing raw material and the selective element-containing raw material for composite microparticles 80 has been described, but a liquid and a gas material containing Ti and Cu can also be evaporated and thus can be used.

In the present first exemplary embodiment, an example of using TiO₂ as a raw material of the second selective element-containing raw material of composite microparticles 80 has been described, but the second selective element-containing raw material is not limited thereto. As the second selective element-containing raw material, a raw material containing one or more elements selected from titanium, germanium, silicon, tin, aluminum, zinc, zirconium, hafnium, iron, yttrium, niobium, tantalum, calcium, magnesium, indium, tungsten, molybdenum, and nickel may be used.

In the present first exemplary embodiment, an example of using the copper element as a raw material of the first selective element-containing raw material of composite microparticles 80 has been described, but the first selective element-containing raw material is not limited thereto. As the first selective element-containing raw material, a raw material containing one or more elements selected from a copper element, a molybdenum element, and a silver element may be used.

The second selective element may be different from the first selective element. The second selective element-containing raw material having a melting point higher than a melting point of the first selective element-containing raw material may be used.

In the method for manufacturing composite microparticles 80 according to the present exemplary embodiment, the thermal plasma method is used, but other methods may be used as long as microparticles having an average particle diameter of less than or equal to 300 nm can be manufactured by evaporating and quenching mixed material 60 such as TiO₂ or CuO. In the thermal plasma method, high frequency thermal plasma, direct current arc plasma, or alternating current arc plasma may be used, and as a method other than the thermal plasma method, a flame method using a burner, a laser ablation method, or a thermal decomposition method using a high frequency heating method or the like may be used.

Although an example in which only argon gas is used as the gas has been described, the present disclosure is not limited thereto. At least one gas of the material supply gas (carrier gas), the discharge gas, and the gas (cooling gas) (not illustrated) introduced from cooling gas supply pipes 90, 91 to the terminal portion of thermal plasma 70 may be used by adding oxygen gas to inert gas such as argon gas.

In the case of synthesizing composite microparticle of TiO₂ and Cu₂O, when only inert gas is used, a part of oxygen derived from a raw material generated by evaporation of the raw material cannot contribute to the reaction, and a part of oxygen is lost, so that metal Cu may be generated. In the mixed gas of the inert gas and the oxygen gas, the content of the oxygen gas is, for example, 0.1 vol % to 50 vol %. By adding oxygen gas to inert gas, oxygen deficiency can be suppressed, and the ratio of Cu₂O can be increased.

At least one gas of the carrier gas, the discharge gas, and the cooling gas may be used by adding oxygen gas and hydrogen gas or a carbon-based reducing gas to inert gas such as argon gas. The oxidation and crystal structure of the oxides of the base particles and the copper element-containing particles may be controlled by the oxygen gas and/or the reducing gas. When the oxygen gas is excessively added, the proportion of CuO in Cu₂O, CuO, and Cu constituting the copper element-containing particles increases, and the proportion of Cu₂O decreases. Therefore, the proportion of Cu₂O can be optimized by further adding hydrogen gas or a carbon-based reducing gas. Since Cu₂O is generated at a temperature lower than that of the oxide of the base particles, a gas to which hydrogen gas or a carbon-based reducing gas is added may be introduced as a cooling gas from the terminal portion of thermal plasma 70. The cooling gas may be supplied upward (Z direction) from the bottom of reaction chamber 20 so as to be countercurrent to the thermal plasma.

In the above description, the oxidation and crystal structure of the oxides of the base particles and/or copper element-containing particles are controlled by controlling the atmosphere of the oxygen gas and/or the reducing gas, but the present disclosure is not limited thereto. For example, among the raw materials, the proportion of Cu₂O in the copper element-containing particles may be controlled by controlling the proportion of Cu₂O, CuO, and Cu in the copper element-containing raw material. Thereby, the proportion of Cu₂O in the copper element-containing particles can be controlled without using a reducing agent. When the selected element is titanium, the proportion between the rutile type titanium oxide and the anatase type titanium oxide in the base particles may be controlled by controlling the proportion between the rutile type titanium oxide and the anatase type titanium oxide as the selective element-containing raw material.

### [Composite Microparticles]

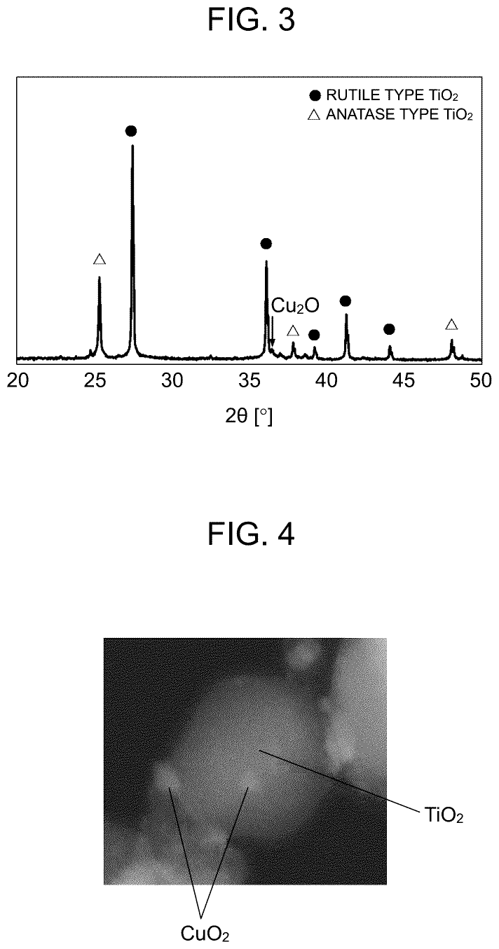

Subsequently, the composite microparticles according to the present first exemplary embodiment will be described with reference to FIGS. 3 and 4. FIG. 3 shows results of powder X-ray diffraction measurement of composite microparticles 80 (hereinafter, composite microparticles of Example 1) obtained by the method for manufacturing composite microparticles 80 according to the present first exemplary embodiment. FIG. 4 is a transmission electron image of composite microparticles of Example 1. The entire width of FIG. 4 is about 30 nm.

In composite microparticles 80 according to the present first exemplary embodiment, as can be seen from the results of the powder X-ray diffraction measurement of FIG. 3, TiO₂ and Cu₂O mainly composed of a rutile type are generated. From the transmission electron image and the elemental analysis in FIG. 4, the surfaces of the TiO₂ microparticles having an average particle diameter of from 10 nm to 300 nm inclusive has a shape in which Cu₂O microparticles having an average particle diameter of from 0.5 nm to 300 nm inclusive are supported. That is, in the composite microparticles, the TiO₂ microparticles mainly composed of rutile type are base particles, and the Cu₂O microparticles are present on the surfaces of the base particles. Since the Cu₂O microparticles are present on the surfaces of the base particles, and the surfaces of the TiO₂ microparticles as the base particles are not entirely covered, it is possible to obtain photocatalytic activity together with high antimicrobial or antiviral performance.

The average particle diameter of the primary particles of each of the base particles and the copper element-containing particles is obtained, for example, by calculating the number average of 100 particles in the transmission electron image.

In the present first exemplary embodiment, a mixture of TiO₂ and CuO at a weight ratio of 90:10 is used as a raw material, but the mixing ratio of composite microparticles 80 can also be controlled by changing the mixing ratio of TiO₂ and CuO. When the proportion of CuO is excessively less than 0.25 wt %, Cu₂O is reduced, and the antiviral performance is deteriorated. Conversely, when the proportion of CuO is increased, TiO₂ is covered with Cu₂O, the antimicrobial or antiviral performance of Cu₂O becomes strong, and the photoresponsiveness is lowered, but deterioration at the time of resin mixing can be suppressed, and coloring can be suppressed more than Cu₂O alone. The proportion of CuO may be increased to 30 wt %. When the proportion is more than 30 wt %, photoresponsiveness is not sufficiently obtained in some cases.

### Second Exemplary Embodiment

In the present second exemplary embodiment, Si is used as the second selective element, SiO₂ is used as a Si-containing raw material, and CuO as a copper-containing raw material is used as the first selective element. As each raw material, a mixture of SiO₂:CuO at a weight ratio of 90:10 is used. The composite microparticle manufacturing method is the same as that in the first exemplary embodiment.

### [Composite Microparticles]

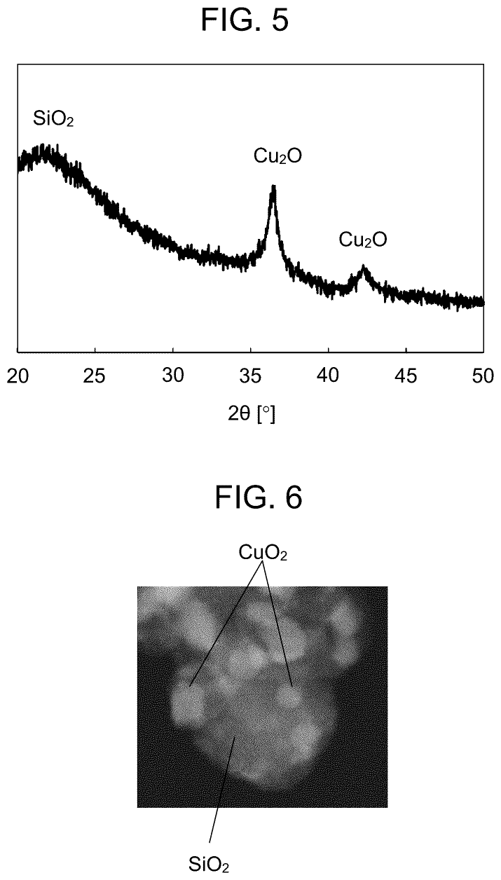

The composite microparticles according to the present second exemplary embodiment will be described with reference to FIGS. 5 and 6. FIG. 5 shows results of powder X-ray diffraction measurement of composite microparticles 80 (hereinafter, composite microparticles of Example 2) obtained by the method for manufacturing composite microparticles 80 according to the present second exemplary embodiment. FIG. 6 is a transmission electron image of composite microparticles of Example 2. The entire width of FIG. 6 is about 30 nm.

In composite microparticles 80 according to the present second exemplary embodiment, as can be seen from the results of the powder X-ray diffraction measurement of FIG. 5, SiO₂ and Cu₂O are generated. From the transmission electron image and the elemental analysis in FIG. 6, the surfaces of the SiO₂ microparticles having an average particle diameter of from 10 nm to 300 nm inclusive has a shape in which Cu₂O microparticles having an average particle diameter of from 0.5 nm to 300 nm inclusive are supported. That is, in the composite microparticles, the SiO₂ microparticles are base particles, and the Cu₂O microparticles are present on the surfaces of the base particles. Since the Cu₂O microparticles are present on the surfaces of the base particles, and the surfaces of the SiO₂ microparticles as the base particles are not entirely covered, transparency is high and antimicrobial or antiviral activity is also high. Since SiO₂ does not have photocatalytic activity, it is possible to suppress deterioration at the time of resin mixing, and to suppress coloring as compared with a case of using Cu₂O alone.

The average particle diameter of the primary particles of each of the base particles and the copper element-containing particles is obtained, for example, by calculating the number average of 100 particles in the transmission electron image.

### Third Exemplary Embodiment

In the present third exemplary embodiment, Si is used as the second selective element, SiO₂ is used as a Si-containing raw material, and MoO₃ as a molybdenum-containing raw material is used as the first selective element. As each raw material, a mixture of SiO₂:MoO₃ at a weight ratio of 90:10 is used. The composite microparticle manufacturing method is the same as that in the first exemplary embodiment.

### [Composite Microparticles]

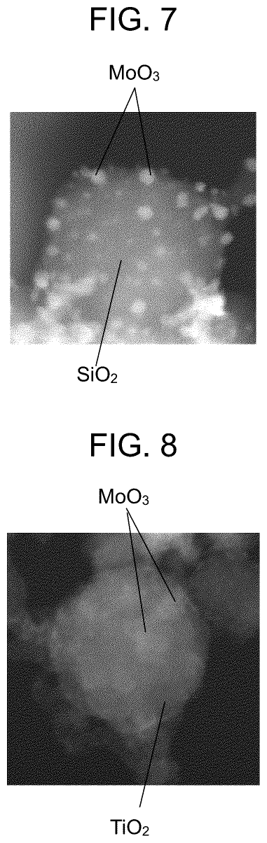

The composite microparticles according to the present third exemplary embodiment will be described with reference to FIG. 7. FIG. 7 is a transmission electron image of composite microparticles of Example 3. The entire width of FIG. 7 is about 40 nm.

In composite microparticles 80 according to the present third exemplary embodiment, from the transmission electron image and the elemental analysis in FIG. 7, the surfaces of the SiO₂ microparticles having an average particle diameter of from 10 nm to 300 nm inclusive has a shape in which Mo-containing microparticles containing MoO₃ having an average particle diameter of from 0.5 nm to 300 nm inclusive are supported. That is, in the composite microparticles, the SiO₂ microparticles are base particles, and the Mo-containing microparticles containing MoO₃ are present on the surfaces of the base particles. Since the Mo-containing microparticles containing MoO₃ are present on the surfaces of the base particles, and the surfaces of the SiO₂ microparticles as the base particles are not entirely covered, transparency is high and antimicrobial or antiviral activity is also high. Since SiO₂ does not have photocatalytic activity, it is possible to suppress deterioration at the time of resin mixing, and to suppress coloring as compared with a case of using the Mo-containing particles containing MoO₃ alone.

The average particle diameter of the primary particles of each of the base particles and the molybdenum element-containing particles is obtained, for example, by calculating the number average of 100 particles in the transmission electron image.

### Fourth Exemplary Embodiment

In the present fourth exemplary embodiment, Ti is used as the second selective element, TiO₂ is used as a Ti-containing raw material, and MoO₃ as a molybdenum-containing raw material is used as the first selective element. As each raw material, a mixture of TiO₂:MoO₃ at a weight ratio of 90:10 is used. The composite microparticle manufacturing method is the same as that in the first exemplary embodiment.

### [Composite Microparticles]

The composite microparticles according to the present fourth exemplary embodiment will be described with reference to FIG. 8. FIG. 8 is a transmission electron image of composite microparticles of Example 4. The entire width of FIG. 8 is about 40 nm.

In composite microparticles 80 according to the present fourth exemplary embodiment, from the transmission electron image and the elemental analysis in FIG. 8, the surfaces of the TiO₂ microparticles having an average particle diameter of from 10 nm to 300 nm inclusive has a shape in which Mo-containing microparticles containing MoO₃ having an average particle diameter of from 0.5 nm to 300 nm inclusive are supported. That is, in the composite microparticles, the TiO₂ microparticles are base particles, and the Mo-containing microparticles containing MoO₃ are present on the surfaces of the base particles. Since the Mo-containing microparticles containing MoO₃ are present on the surfaces of the base particles, and the surfaces of the TiO₂ microparticles as the base particles are not entirely covered, transparency is high and antimicrobial or antiviral activity is also high. The coloring can be suppressed as compared with a case of using Mo-containing particles containing MoO₃ alone.

The average particle diameter of the primary particles of each of the base particles and the molybdenum element-containing particles is obtained, for example, by calculating the number average of 100 particles in the transmission electron image.

### Fifth Exemplary Embodiment

In the present fifth exemplary embodiment, Ti is used as the second selective element, TiO₂ is used as a Ti-containing raw material, and CuO as a copper-containing raw material and MoO₃ as a molybdenum-containing raw material are used as the first selective element. As each raw material, a mixture of TiO₂:CuO:MoO₃ at a weight ratio of 90:5:5 is used. The composite microparticle manufacturing method is the same as that in the first exemplary embodiment.

### [Composite Microparticles]

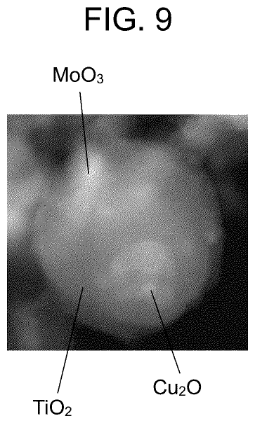

The composite microparticles according to the present fifth exemplary embodiment will be described with reference to FIG. 9. FIG. 9 is a transmission electron image of composite microparticles of Example 5. The entire width of FIG. 9 is about 50 nm.

In composite microparticles 80 according to the present fifth exemplary embodiment, from the transmission electron image and the elemental analysis in FIG. 9, the surfaces of the TiO₂ microparticles having an average particle diameter of from 10 nm to 300 nm inclusive has a shape in which Cu-containing microparticles containing Cu₂O and Mo-containing microparticles containing MoO₃ having an average particle diameter of from 0.5 nm to 300 nm inclusive are supported. That is, in the composite microparticles, the TiO₂ microparticles are base particles, and the Cu-containing microparticles containing Cu₂O and the Mo-containing microparticles containing MoO₃ are present on the surfaces of the base particles. Since the Cu-containing microparticles containing Cu₂O and the Mo-containing microparticles containing MoO₃ are present on the surfaces of the base particles, and the surfaces of the TiO₂ microparticles as the base particles are not entirely covered, transparency is high and antimicrobial or antiviral activity is also high. The coloring can be suppressed as compared with a case of using the Cu-containing microparticles containing Cu₂O and the Mo-containing particles containing MoO₃ alone. Since the Mo-containing particles containing MoO₃ have lower colorability than the Cu-containing particles containing Cu₂O, the supported microparticles can be more colored and suppressed than the Cu-containing particles containing Cu₂O alone. The color can also be toned by controlling the ratio of the Mo-containing particles containing MoO₃ and Cu-containing particles containing Cu₂O.

The average particle diameter of the primary particles of each of the base particles, the copper element, and the molybdenum element-containing particles is obtained, for example, by calculating the number average of 100 particles in the transmission electron image.

As the oxide of the base particles, the oxide of the base particle may be an oxide or composite oxide containing one or more elements selected from titanium, germanium, silicon, tin, aluminum, zinc, zirconium, hafnium, iron, yttrium, niobium, tantalum, calcium, magnesium, indium, tungsten, molybdenum, and nickel. With the selective element-containing oxide or composite oxide, coloring can be suppressed as compared with a case of using Cu₂O alone since the oxide or composite oxide is a white particle having high transmittance.

Therefore, in a resin composition, a resin molded body, or a sheet-shaped resin molded body containing composite microparticles produced by thermal plasma, for example, when the composite microparticles were mixed in an amount of less than or equal to 3 wt %, mixing can be performed while maintaining transparency.

This time, the composite microparticles have been kneaded into a resin mainly composed of polypropylene. The resin may be, for example, a resin mainly composed of polyethylene, polystyrene, acryl, methacryl, polyethylene terephthalate (PET), polycarbonate, or the like.

In a metal and ceramic molded body containing the composite microparticles prepared by thermal plasma, for example, when the composite microparticles were mixed in an amount of less than or equal to 3 wt %, mixing can be performed while maintaining the color of the main component.

### Examples

### [Evaluation of Antimicrobial Activity]

Hereinafter, evaluation results of the antimicrobial activity using composite microparticles 80 obtained by the method for manufacturing composite microparticles 80 according to the present first exemplary embodiment and the present second exemplary embodiment will be described.

### [Evaluation Member]

Preparation of members for evaluating antimicrobial activity will be described.

### <Preparation of Dispersion of Composite Microparticles>

First, the Cu₂O-supported TiO₂ microparticles manufactured in the present first exemplary embodiment and the Cu₂O-supported SiO₂ microparticles manufactured in the present second exemplary embodiment were prepared as composite microparticles. DISPERBYK (registered trademark)-111 manufactured by BYK Japan KK was prepared as a dispersant.

A dispersion of composite microparticles dispersed in methyl ethyl ketone was obtained by adding 10 parts by mass of composite microparticles to 88 parts by mass of methyl ethyl ketone and gradually adding 2 parts by mass of a dispersant while the mixture was dispersed with a bead mill. The solid content of the dispersion of composite microparticles was 10 mass %. The average secondary particle diameter of the composite microparticles measured by a dynamic light scattering method was 115 nm for the Cu₂O-supported TiO₂ microparticles and 110 nm for the Cu₂O-supported SiO₂ microparticles.

### <Preparation of Coating Agent Composition>

First, methyl ethyl ketone-dispersed silica sol MEK-ST manufactured by Nissan Chemical Corporation was prepared. The SiO₂ content in the silica sol was 30 mass %. The primary particle diameter of SiO₂ was 10 nm to 20 nm, and the average secondary particle diameter of SiO₂ measured by a dynamic light scattering method was 30 nm. An acrylic resin for isocyanate curing, ACRYDIC A801 (solid content: 50 mass %) manufactured by DIC Corporation and polyisocyanate DURANATE TPA100 (solid content: 100 mass %) manufactured by Asahi Kasei Chemicals Corporation were also prepared.

First, 20 parts by mass of the silica sol, 10 parts by mass of the acrylic resin, 0.9 parts by mass of polyisocyanate, and 34.1 parts by mass of methyl ethyl ketone were mixed with 35 parts by mass of the dispersion of composite microparticles, and the mixture was stirred using a stirrer. Thereby, 100 parts by mass of the coating agent composition of the present example was prepared.

### <Preparation of Antimicrobial or Antiviral Member>

The coating agent composition was applied to a polyethylene terephthalate film using a bar coater #20, heated and dried at 80° C. for 5 minutes, and then cured at room temperature for 24 hours. Thereby, an antimicrobial member for evaluation of the present example was obtained. As the polyethylene terephthalate film, Teijin Tetoron Film (registered trademark) HPE (PET thickness: 50 μm) manufactured by DuPont Teijin Films was used. The film thickness after curing was measured with a micrometer and found to be 2.5 μm.

The antimicrobial member coated with the coating agent composition was subjected to the following evaluation test.

### [Antimicrobial Performance]

The coating film was subjected to a test in accordance with JIS R1752 (Fine ceramics (advanced ceramics, advanced technical ceramics)—Test method for antibacterial activity of photocatalytic materials and efficacy under indoor lighting environment). A test object was E. coli. As a sharp cut filter in the test, a Type B sharp cut filter (cutting ultraviolet rays of less than 380 nm) specified in JIS R1750 was used. After 4 hours, the number of viable bacteria was measured, and the antimicrobial activity was calculated.

Both the Cu₂O-supported TiO₂ microparticles manufactured in the present first exemplary embodiment and the Cu₂O-supported SiO₂ microparticles manufactured in the present second exemplary embodiment had an antimicrobial activity of more than or equal to 2 (4 hours).

Therefore, it was found that both the Cu₂O-supported TiO₂ microparticles manufactured in the present first exemplary embodiment and the Cu₂O-supported SiO₂ microparticles manufactured in the present second exemplary embodiment had excellent antimicrobial activity.

Note that the present disclosure includes an appropriate combination of any exemplary embodiment and/or example among the various above-described exemplary embodiments and/or examples, and effects of each of the exemplary embodiments and/or examples can be achieved.

### INDUSTRIAL APPLICABILITY

With the composite microparticle manufacturing method according to the present disclosure, it is possible to easily obtain composite microparticles including base particles having an average particle diameter of 10 nm to 300 nm and containing an oxide of a selected element, and microparticles having an average particle diameter of from 0.5 nm to 300 nm inclusive, composed of at least one of cuprous oxide, copper oxide, copper, molybdenum oxide, silver oxide, and silver, and being present on surfaces of the base particles. The composite microparticles have high catalytic performance or antimicrobial or antiviral performance and high transparency. It is possible to produce a large amount of microparticles in a short time with less contamination of impurities, which is user as the composite microparticle manufacturing method.

### REFERENCE MARKS IN THE DRAWINGS

10: material supply unit
20: reaction chamber
30: pump
31: conductance valve
40, 41: gas supply pipe
42: material supply pipe
50: bag filter
60: material
70: thermal plasma
80: composite microparticles
90, 91: cooling gas supply pipe

1. A composite microparticle manufacturing method comprising:
a step of preparing a first selective element-containing raw material and a second selective element-containing raw material, the first selective element-containing raw material containing one or more first selective elements selected from a copper element, a molybdenum element, and a silver element, the second selective element-containing raw material containing one or more second selective elements selected from titanium, germanium, silicon, tin, aluminum, zinc, zirconium, hafnium, iron, yttrium, niobium, tantalum, calcium, magnesium, indium, tungsten, molybdenum, and nickel; and
a composite microparticle generation step of introducing both of the prepared raw materials into thermal plasma, evaporating the raw materials, and cooling the evaporated raw materials to generate composite microparticles including base particles and first selective element-containing microparticles being present on surfaces of the base particles, the base particles having an average particle diameter of from 10 nm to 300 nm inclusive and containing one or more oxides of the selected one or more second selective elements, the first selective element-containing microparticles having an average particle diameter of from 0.5 nm to 300 nm inclusive and composed of at least one of cuprous oxide, copper oxide, copper, molybdenum oxide, silver oxide, and silver.

2. The composite microparticle manufacturing method according to claim 1, wherein the second selective element-containing raw material has a melting point higher than a melting point of the first selective element-containing raw material.

3. The composite microparticle manufacturing method according to claim 1, wherein the first selective element-containing microparticles are copper element-containing particles, and
the composite microparticle generation step includes controlling an atmosphere such that an abundance ratio of cuprous oxide in the copper element-containing particles present on the surfaces of the base particles is more than or equal to 20 mol %.

4. The composite microparticle manufacturing method according to claim 1, wherein the one or more second selective elements is titanium and the one or more oxides of the one or more second selective elements includes titanium oxide, and
the composite microparticle generation step includes controlling an atmosphere such that a content of rutile type titanium oxide in the titanium oxide is more than or equal to 50 mol %.

5. The composite microparticle manufacturing method according to claim 1, wherein a discharge gas of the thermal plasma is at least one of inert gas, oxygen gas, and hydrogen gas.

6. The composite microparticle manufacturing method according to claim 1, wherein a discharge gas of the thermal plasma is a mixed gas of inert gas and oxygen gas, the oxygen gas being 0.1 vol % to 50 vol % in the mixed gas.

7. The composite microparticle manufacturing method according to claim 1, wherein the composite microparticle generation step includes supplying a cooling gas to a terminal portion of the thermal plasma.

8. The composite microparticle manufacturing method according to claim 7, wherein the cooling gas is at least one of oxygen gas and hydrogen gas.

9. Composite microparticles comprising:
base particles having an average particle diameter of from 10 nm to 300 nm inclusive and containing an oxide of one element selected from germanium, silicon, tin, aluminum, zinc, zirconium, hafnium, iron, yttrium, niobium, tantalum, calcium, magnesium, indium, tungsten, molybdenum, and nickel; and
microparticles being present on surfaces of the base particles, the microparticles having an average particle diameter of from 0.5 nm to 300 nm inclusive and composed of at least one of cuprous oxide, copper oxide, copper, molybdenum oxide, silver oxide, and silver.

10. Composite microparticles comprising:
base particles having an average particle diameter of from 10 nm to 300 nm inclusive and containing two or more oxides of two or more elements selected from titanium, germanium, silicon, tin, aluminum, zinc, zirconium, hafnium, iron, yttrium, niobium, tantalum, calcium, magnesium, indium, tungsten, molybdenum, and nickel; and
microparticles being present on surfaces of the base particles, the microparticles having an average particle diameter of from 0.5 nm to 300 nm inclusive and composed of at least one of cuprous oxide, copper oxide, copper, molybdenum oxide, silver oxide, and silver.

11. The composite microparticles according to claim 10, wherein the two or more oxides of the selected two or more elements include titanium oxide, and a content of rutile type titanium oxide in the titanium oxide is more than or equal to 50 mol %.

12. The composite microparticles according to claim 9, wherein the microparticles are copper element-containing particles, and
an abundance ratio of cuprous oxide in the copper element-containing particles is more than or equal to 20 mol %.

13. A resin composition comprising:
a resin; and
the composite microparticles according to claim 9 in the resin.

14. A resin molded body comprising:
a resin; and
the composite microparticles according to claim 9 in the resin.

15. A transparent sheet-shaped resin molded body comprising:
a resin; and
the composite microparticles according to claim 9 in the resin.

16. A metal and ceramic molded body comprising:
a resin; and
the composite microparticles according to claim 9 in the resin.

17. The composite microparticles according to claim 10, wherein the microparticles are copper element-containing particles, and
an abundance ratio of cuprous oxide in the copper element-containing particles is more than or equal to 20 mol %.

18. A resin composition comprising:
a resin; and
the composite microparticles according to claim 10 in the resin.

19. A resin molded body comprising:
a resin; and
the composite microparticles according to claim 10 in the resin.

20. A transparent sheet-shaped resin molded body comprising:
a resin; and
the composite microparticles according to claim 10 in the resin.

21. A metal and ceramic molded body comprising:
a resin; and
the composite microparticles according to claim 10 in the resin.
